(19) United States
(12) Patent Application Publication
(10) Pub. No.: US 2007/0065198 A1
(43) Pub. Date: Mar. 22, 2007

(54) Document restraint arrangement for reproduction apparatus and method of using

(75) Inventor: Julie Watson, Yukon, OK (US)

Correspondence Address: SHLESINGER & FITZSIMMONS, 183 EAST MAIN STREET, SUITE 1323, ROCHESTER, NY, 14604, US

(73) Assignee: Xerox Corporation

(21) Appl. No.: 11/225,416

(22) Filed: Sep. 13, 2005

(51) Int. Cl. G03G 15/00

(52) U.S. Cl. 399/380

(57) ABSTRACT

One or more strips along the platen of a scanner, copier, or the like include a clip portion that holds documents in place for reproduction. Embodiments include indicia on the clip portion to assist with document placement. A tongue of the clip portion engages the platen to hold the documents. Recesses in the cover, a pad on the cover, or a resizing of the pad on the cover allow the cover to close with the clips of embodiments in place. Alternatively, the strips can be substantially flush or very low profile, such as by placing them in grooves adjacent the platen, so as to allow closure of the cover with little or no interference.

### BACKGROUND AND SUMMARY

Copying small items, such as photographs or receipts, especially when such items do not lay flat, can be very difficult. Many such documents are not standard size and require that the machine lid be lifted open to read the size of the document. To copy them, one must typically hold them in place manually or use tape or the like to hold them in place. When shutting the lid, the items, particularly lightweight paper, tend to move or slip so that the items become misaligned and are not scanned or copied properly. This is especially difficult when one is trying to scan or copy multiple items, such as receipts. A slight movement of the lid can cause the papers to move on the platen. As mentioned, one solution is to tape the items in place, either directly to the platen or to a larger sheet of paper for copying. However, this is inefficient and can dirty the platen with adhesive. Thus, there is a need for an arrangement that will hold small items in place while the cover is lowered so that the items stay properly aligned for scanning and/or copying.

Embodiments comprise low profile clips attached along, for example, the top and left edges of the glass. Such clips would allow items to be held in place for copying or scanning. The clips of embodiments are preferably of low enough profile to allow the copier lid to close without removing the clips. Further, embodiments include recessed areas in the lid to accommodate the clips without interfering with the lid closing.

The clips of embodiments can be made out of a durable material and can be made in different sizes to fit the size of the glass of various machines. Additional embodiments allow for generic clips that can be sold as accessories. Further, embodiments can include marks that are normally printed along the edge of the glass printed on the top of the clips to allow proper alignment with the marks when the clips are present.

### BRIEF DESCRIPTION OF THE DRAWINGS

FIG. 1 is a schematic view of a reproduction apparatus with which embodiments can be used.

FIG. 2 is an enlarged view of a top of a reproduction apparatus with which embodiments can be used.

FIG. 3 is a schematic cross section of embodiments.

FIG. 4 is a schematic cross section of an alternate configuration of embodiments.

FIG. 5 is a schematic flow diagram of a method according to embodiments.

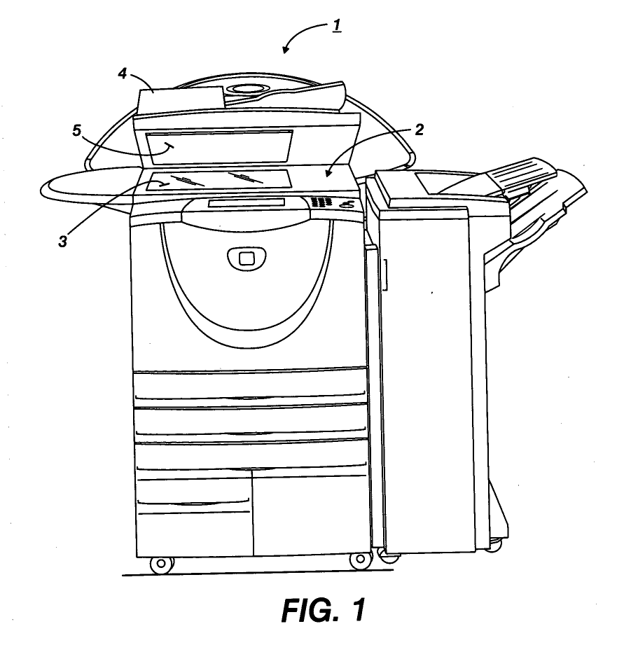

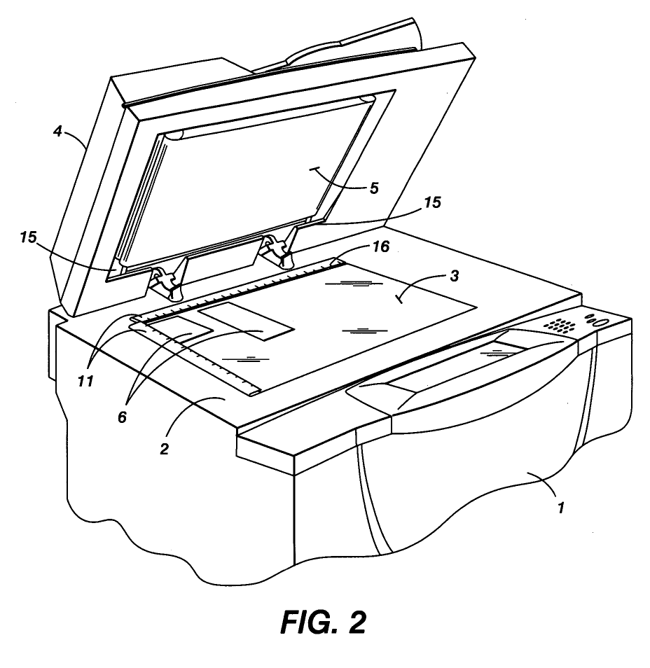

### DESCRIPTION

Reference is made to the accompanying drawings in which exemplary embodiments are shown. The embodiments shown and described are exemplary and are not limiting.

Embodiments comprise low profile restraint apparatus or clips attached along, for example, the top and left edges of the platen of a reproduction apparatus, such as a scanner or copier. Such clips would allow items to be held in place for copying or scanning. The clips of embodiments are preferably of low enough profile to allow the copier lid to close without removing the clips. Further, embodiments can include recessed areas in the lid to accommodate the clips without interfering with the lid closing.

The clips of embodiments can be made out of a durable material and can be made in different sizes to fit the size of the glass of various machines. Additional embodiments allow for generic clips that can be sold as accessories. Further, embodiments can include marks that are normally printed along the edge of the glass printed on the top of the clips to allow proper alignment with the marks when the clips are present.

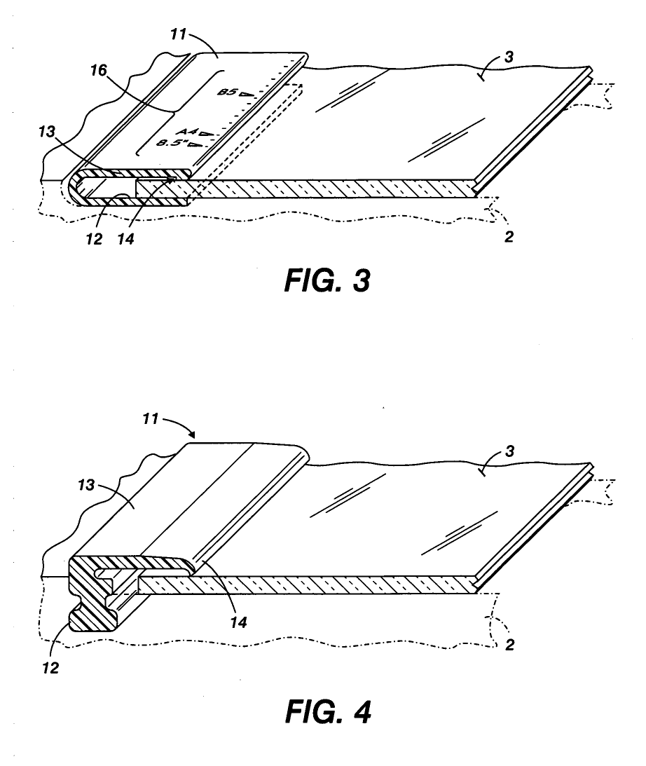

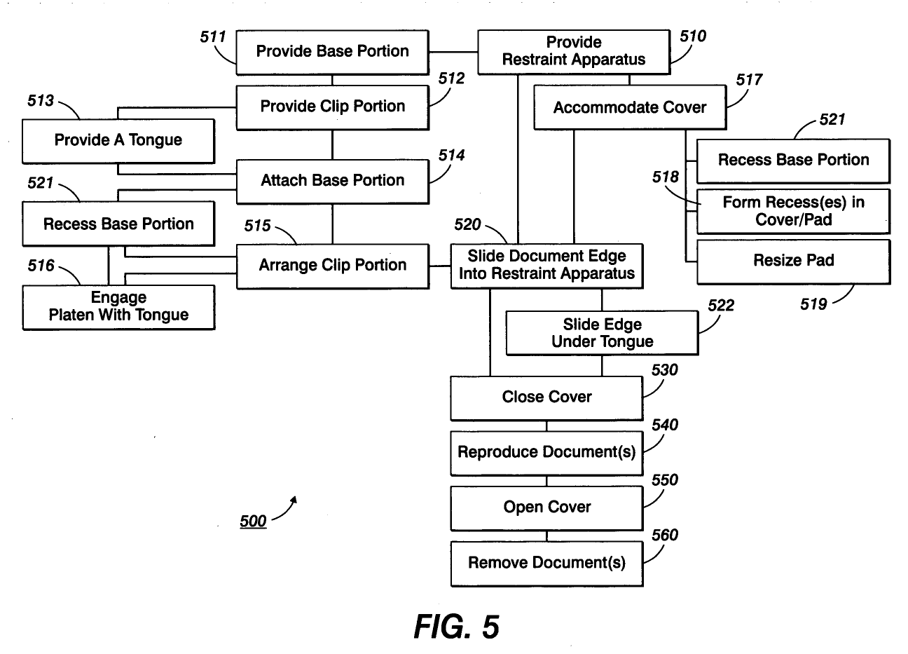

Thus, embodiments contemplate a restraint apparatus 10, preferably in the form of a clip, for a reproduction apparatus 1, such as a scanner or copier, that has a top surface 2, a platen 3 on the top surface 2, and a cover 4 selectively placed atop the platen 3. Embodiments include at least one strip 11 sized to fit a respective edge of the platen 3. Each strip 11 has a base portion 12 and a clip portion 13. The clip portion 13 of embodiments extends parallel to the surface of the platen 3 and preferably includes a tongue 14 extending toward and engaging the platen 3 or the top surface 2 of the reproduction apparatus 1. The base portion 12 can also be parallel to the platen surface and affixed to the top surface 2 of the reproduction apparatus 1, as seen in FIG. 3. Alternatively, as seen in FIG. 4, the base portion 12 can extend into a recess or groove in the top surface 2 of the platen and be held in the recess, such as by a pressfit, adhesive, and/or fasteners and the like. Embodiments can have all but the clip portion 13 flush with or below the level of the top surface 2, or can have recesses 15 formed in the cover 4 or a pad 5 on the cover 4, or can have a pad 5 on the cover 4 resized, all to allow the cover 4 to close. Additionally, embodiments provide for indicia 16 to be included on the strip 11, such as paper size markings that would be found on or adjacent edges of the platens of machines not using embodiments.

In use, embodiments contemplate a method 500 of restraining at least one document on a platen of the reproduction apparatus. First, one or more of the restraint apparatus must be in place. The user slides the edge of a document into the clip portion, positions the document, closes the cover, reproduces the document, opens the cover, and removes the document. In embodiments including a tongue on the clip portion, the user slides the edge of the document under the tongue so that the tongue holds the edge of the document against the top surface or the platen, as in a pressfit, for example. In embodiments, two restraint apparatus are provided, one along each of two edges of the platen, and documents can employ both apparatus simultaneously. To achieve the desired restraint, the apparatus is preferably made from a flexible and/or elastomeric compound.

Thus, the method 500 includes providing a restraint apparatus 510, which can comprise providing a base portion 511, providing a clip portion 512, and providing a tongue 513. Providing a restraint apparatus 510 can further include attaching a base portion 514 and arranging the clip portion 515. Attaching a base portion can include recessing the base portion 521 and engaging the platen with the tongue 516. Additionally, providing a restraint apparatus can include accommodating the cover 517, which can include recessing the base portion 521, forming reces(es) in the cover/pad 518, and/or resizing the pad 519. The overall method 500 further comprises sliding an edge of a document into the restraint apparatus 520, closing the cover 530, reproducing the document(s) 540, opening the cover 550, and removing the document(s). Sliding the document 520 can include sliding an edge of the document under the tongue 522.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. In a reproduction apparatus comprising a top surface, a platen on the top surface, and a cover selectively placeable on the platen, a document restraint arrangement comprising at least one strip sized to fit a respective edge of the platen and so as to allow the cover to close, the at least one strip further being arranged to hold an edge of at least one document such that the at least one document will remain in a desired position substantially free of curl and substantially stationary when the cover is opened and closed.

2. The arrangement of claim 1 wherein the at least one strip further comprises indicia thereon to assist with proper placement of the document on the platen.

3. The arrangement of claim 1 wherein the at least one strip comprises two strips on respective orthogonal edges of the platen.

4. The arrangement of claim 1 wherein the at least one strip is at least partially recessed into a top surface of the reproduction apparatus, thereby allowing the cover to close.

5. The arrangement of claim 4 wherein the at least one strip further comprises a support portion and a clip portion, the support portion of the at least one strip being recessed into the top surface of the reproduction apparatus and the at least one strip further comprises a clip portion substantially parallel to the surface of the platen, the clip portion comprising a tongue that engages the platen such that inserting an edge of a document thereunder will create a pressfit of the document against the platen, which pressfit can be broken by pulling the document out of the clip.

6. The arrangement of claim 5 wherein the base and clip portions are made from an elastomeric resin.

7. The arrangement of claim 1 wherein the cover includes at least one respective recess to accommodate the at least one restraint apparatus.

8. The arrangement of claim 1 wherein the cover includes a pad that is reduced in size to accommodate the at least one clip.

9. In a reproduction apparatus comprising a top surface, a platen on the top surface, and a cover selectively placed atop the platen, a method of restraining at least one document on a platen of the reproduction apparatus comprising:
providing a restraint apparatus along at least one edge of the platen;
sliding at least one respective edge of at least one document into the restraint apparatus;
closing the cover;
reproducing the at least one document with the reproduction apparatus;
opening the cover; and
removing the at least one document from the restraint apparatus.

10. The method of claim 9 wherein providing a restraint apparatus comprises providing at least one base portion and at least one clip portion, attaching the at least one base portion to the top surface of the reproduction apparatus, and arranging the clip portion such that the clip portion is substantially parallel to the platen.

11. The method of claim 10 wherein attaching the at least one base portion comprises recessing the at least one base portion into the top surface of the reproduction apparatus.

12. The method of claim 10 wherein providing a restraint apparatus further comprises providing a tongue on the clip portion projecting substantially orthogonally to the clip portion, arranging the clip portion further comprises engaging the platen with a tongue on the clip portion, and inserting the at least one respective edge comprises sliding the edge under the tongue so that the tongue restrains the document in a pressfit between the tongue and the platen.

13. The method of claim 9 wherein providing comprises forming the restraint apparatus from an elastomeric resin.

14. The method of claim 9 further comprising forming at least one respective recess in the cover to accommodate the at least one restraint apparatus.

15. The method of claim 9 further comprising resizing a pad of the cover to accommodate the at least one clip.

16. In a reproduction apparatus comprising a top surface, a platen on the top surface, and a cover selectively placed atop the platen, and a restraint apparatus comprising:
at least one strip sized to fit a respective edge of the platen and so as to allow the cover to close;
a support portion of the at least one strip recessed into a top surface of the reproduction apparatus;
a clip portion of the at least one strip extending from the base portion substantially parallel to the surface of the platen; and
a tongue of the clip portion that engages the platen; and
a method of restraining at least one document on a platen of the reproduction apparatus comprising:
providing a restraint apparatus along at least one edge of the platen;
sliding at least one respective edge of at least one document into the restraint apparatus;
closing the cover;
reproducing the at least one document with the reproduction apparatus;
opening the cover; and
removing the at least one document from the restraint apparatus.

17. The method of claim 16 further comprising engaging the platen with the tongue on the clip portion, and inserting the at least one respective edge comprises sliding the edge under the tongue so that the tongue restrains the document in a pressfit between the tongue and the platen.

18. The method of claim 16 wherein providing further comprises forming the restraint apparatus from a substantially elastomeric compound.

19. The method of claim 16 further comprising forming at least one respective recess in the cover to accommodate the at least one restraint apparatus.

20. The method of claim 16 further comprising resizing a pad of the cover to accommodate the at least one clip.
